(19) United States
(12) Patent Application Publication
(10) Pub. No.: US 2022/0185586 A1
(43) Pub. Date: Jun. 16, 2022

(54) CONTACTLESS CUSTOMER ORDER PICK-UP PORTAL

(71) Applicant: Dematic Corp., Grand Rapids, MI (US)

(72) Inventors: William R. Boer, Wayland, MI (US); David Brumels, Jenison, MI (US); Rustin Fike, Rockford, MI (US); Veronique Cole, Greenville, MI (US); John Plantamura, Grand Rapids, MI (US)

(21) Appl. No.: 17/547,643

(22) Filed: Dec. 10, 2021

Related U.S. Application Data
(60) Provisional application No. 63/124,146, filed on Dec. 11, 2020.

(51) Int. Cl. B65G 1/137; B65G 1/02; B65G 1/04

(52) U.S. Cl. CPC B65G 1/1376; B65G 1/0485; B65G 1/023

(57) ABSTRACT

A contactless order dispensing system is provided for dispensing e-commerce orders to customers at a store without a person-to-person interaction. The dispensing system includes a customer access portal for presenting orders to the customer, preferably at an exterior location. A transportation system (e.g. conveyer system) transports orders from a storage buffer system to the customer access portal. The storage buffer holds customer orders until the customer arrives to retrieve them and may store portions of orders at different temperatures. The dispensing system includes a confirmation sensor system to verify whether a customer has retrieved their entire order or whether the customer has rejected one or more of the order items. The dispensing system provides the order to the customer within about two minutes of the customer indicating that they are at the access portal and ready for their order.

### CROSS REFERENCE TO RELATED APPLICATION

The present application claims priority of U.S. provisional application Ser. No. 63/124,146, filed Dec. 11, 2020, which is hereby incorporated herein by reference in its entirety.

### FIELD OF THE INVENTION

The present invention is directed to order fulfillment, and in particular to and methods for dispensing orders to a customer.

### BACKGROUND OF THE INVENTION

Order fulfillment of orders placed over the internet must take place within a relatively short period of time in order to be commercially competitive. The same could be said for orders received by phone, facsimile, or by the mail based on catalog or television-based merchandizing. Such order fulfillment is known as e-commerce and places demands on an order fulfillment system to meet such obligations. In micro-fulfillment settings, customers place orders directly with a grocery store, department store, retail store, or the like. When the customer arrives at the store they expect to conveniently pick-up their completed order and to do so in a short period of time. Public health concerns may be worsened due to increased exposure with other individuals, such as when shopping and interacting with other customers and store associates, and from touching multiple surfaces and items when shopping in a retail or grocery store.

### SUMMARY OF THE INVENTION

The present invention provides a contactless customer order dispensing system that presents customer orders to the customer at the time of pickup without contact with a store associate. Presenting e-commerce orders to customer at the store can be a labor intensive and time sensitive activity that is potentially unsafe from a health standpoint. Customers also want their order immediately when they come to the store to pick it up. The dispensing system includes a customer order pick-up or access portal that presents the customer's order for pickup while the customer remains on the exterior of the store and without the assistance of a store associate. The order access portal includes a customer/user interface or system having a computer display, with which the customer interacts. The term contactless refers to a lack of person-to-person contact between the customer and another human, while the access portal may require the customer to contact some surfaces to request their order and to retrieve it. The dispensing system includes a transportation system with an order handling conveyor system that transports the customer order from a storage buffer to the order access portal. The storage buffer may be automated or operated manually by human operators. The access portal includes safety controls to insure that the customer is not injured during the presentation and retrieval of their order. The safety controls are part of a confirmation system that monitors the full/empty condition of an order container (e.g. receptacle, tote, bin, etc.) to determine if the customer has retrieved their entire order from the access portal. A shroud that includes a covering over the mechanical elements of the access portal is provided to make the access portal aesthetically appealing and provides additional protection for the customer along with the safety devices to prevent injury to customers and untrained users when they interact with the dispensing system. Optionally, the shroud may be sized and shaped to have an opening that is smaller than a receptacle that the order is transported and presented to the customer in such that the customer may not remove the receptacle from the access portal.

The storage buffer is typically an automated storage and retrieval system (ASRS) that stores filled customer order until the customer arrives at the store and quickly retrieves the customer order when the customer has arrived. However, it will be appreciated that a manual buffer system may be provided in the alternative. Autonomous mobile robots (AMRs) may be used in addition to or alternative to the conveyor system of the transportation system thereby reducing the space and infrastructure requirements for the store. In addition to other benefits, the dispensing system and method may eliminate direct human-to-human contact by dispensing an order to the customer without human interaction, prevents the customer from mistakenly or purposefully taking the order container when picking up their order of groceries, presents the order to customer in about two minutes of the customer's arrival at the access portal.

According to one form of the present invention, a contactless order dispensing system for dispensing e-commerce orders to customers without the requirement of human-to-human interaction. The dispensing system includes a customer access portal at which an order is presented to a customer for retrieval without interaction with a human associate. The dispensing system includes a transportation system and a storage buffer. The transportation system is in transport communication with the customer access portal and the storage buffer. The transportation system moves items between the storage buffer and the customer access portal. The storage buffer stores/buffers prepared customer orders until a particular one of the orders is requested at the customer access portal by its corresponding customer. The storage buffer subsequently releases that order to be transported to the customer access portal. The storage buffer receives the prepared orders from an on-site order fulfilment facility at the store. The dispensing system includes an order management system having a computer that controls the dispensing system.

A confirmation sensor system is provided with the dispensing system and is in communication with the order management system. The confirmation sensor system is operable to verify that the customer retrieved all of the order contents from the customer access portal or confirm that an item is present in the customer access portal if the customer has indicated that they are rejected an item of the order. The confirmation sensor system may be operable to recognize if a customer has rejected an item from the order based on a customer input at the customer user interface indicating that the customer has intentionally left the item in the customer access portal. The dispensing system may also include a customer alert device to notify the customer if they have left an item in the customer access portal. The confirmation sensor system may include touchless sensors and user interfaces to reduce the need for the customer to touch surfaces when retrieving their order. Such touchless sensors may include biometric scanners, light curtains, proximity sensors, voice activated sensors, motion sensors, and the like. Sensors of the confirmation sensor system transmit data to the order management system and computer.

In one aspect, the transportation system includes a conveyor system having one or more of a roller conveyor system, a segmented belt on roller (SBOR) system, a belt conveyor system, and a right-angle transfer (RAT) system. In one aspect, the customer order is transported within a receptacle, and the receptacle is transported by the conveyor system and the order is ultimately presented to the customer at the customer access portal in the receptacle. The conveyor system may be operable to accumulate and sequence multiple orders or multiple portions of orders at the customer access portal, such that each receptacle for a customer order is indexed and sequenced so the customer receives all of their order in sequential receptacles. In another aspect, the transportation system may include an autonomous mobile robot (AMR) that moves the orders between the storage buffer and the customer access portal.

In one aspect, the buffer includes a plurality of temperature zones for storing respective portions of an order at different respective required temperatures until the order is requested at the customer access portal. When the customer arrives at the customer access portal, each portion of the order is released from the respective temperature zone of the buffer such that the entire order arrives at the customer access portal simultaneously or at substantially the same time.

In another aspect, the contactless order dispensing system includes a customer/user interface or system in communication with the order management system. The customer user interface includes a customer input device, such as an analog keypad, touchscreen, or scanner, to receive a customer input indicating that the customer is ready to retrieve the order. Upon receiving the customer input at the customer user interface, the order management system instructs the storage buffer to release the customer order to be transported to the customer access portal. Preferably, the dispensing system, upon receiving instructions from the customer that they are ready for their order, retrieves the order from the buffer and presents it to the customer at the customer access portal in about ten (10) minutes, more preferably within about five (5) minutes, and most preferably within two (2) minutes or less.

In still another aspect, the dispensing system includes a plurality of the customer access portals in spaced arrangement and the transportation system includes a sortation system to direct particular orders to their respective customers at respective ones of the plurality of customer access portals.

According to another form of the present invention, a method is provided for contactless dispensing of an order to a customer and includes preparing an order for a customer within an order fulfilment facility that is on-site at the store (e.g. grocery store, department store, retail store, etc.). The method includes buffering the order in a storage buffer until the customer arrives to pick-up the order. Once the customer indicates that they have arrived at the store, the method includes transporting the order from the storage buffer with a transportation system. The order is received from the transportation system at a customer access portal and the order is subsequently dispensed to the customer with the customer access portal in a manner such that the customer does not have direct contact with another human. The method includes confirming that the customer has retrieved their entire order from the customer access portal, such as with an optical sensor, ultrasound sensor, laser, or similar sensor.

In one aspect, the buffering the order in a storage buffer includes storing portions of the order in different temperature zones of the storage buffer as required for the different items in the order. For example, if an order contains items that may be stored at ambient temperature and items that require freezing, the ambient temperature items are stored in an ambient storage zone and the frozen items are stored in a frozen zone of the storage buffer. In another aspect, the storage buffer is an automated buffer and includes an automated storage and retrieval system and buffering the order in a storage buffer is performed by the automated storage and retrieval system. Alternatively, the storage buffer may be a manual storage and retrieval system in which human operators store and retrieve the orders.

In another aspect, confirming that the customer has retrieved their order is performed by an order management system that includes a computer and a confirmation sensor system at the customer access portal. The confirmation sensor is in communication with the order management system and transmits data, such as image data, to the order management system. It yet another aspect, the dispensing the order to the customer includes opening an access door between the customer and the transportation system and presenting the order to the customer at the opening defined by the open access door. The method may include notifying a customer that an order item is present at the customer access portal and ready for retrieval. Either notifying the customer that the order has arrived or that they have unintentionally left an order item in the customer access portal.

In still another aspect, the method may include receiving an instruction from the customer that they are rejecting at least one order item and the method includes confirming that the rejected item is present at the customer access portal. In other words, the method confirms that the customer has left the rejected item in the access portal. Preferably, the method performs transporting the order from the storage buffer, receiving the order at the customer access portal, and dispensing the order to the customer less than about ten (10) minutes, more preferably in less than about five (5) minutes, and most preferably in less than about two (2) minutes or less.

Accordingly, the present invention provides a contactless dispensing system and method for contactless presentation of a customer's e-commerce order to the customer at an exterior of the store without the customer interacting with a human associate. The dispensing system includes a customer order pick-up or access portal where the customer receives their order. The dispensing system utilizes an automated storage and retrieval system (ASRS) to buffer customer orders until the customer arrives at the store. A transportation system is disposed between the ASRS and the customer access portal to move the orders from the buffer to the access portal. The dispensing system eliminates the need for human interaction when the customer arrives to pick-up their order and provides the order to the customer in a short period of time, thus reducing the amount of time the customer must wait at the store. The dispensing system includes various safety devices and functions to prevent or ensure that the customer or an untrained user is not injured when retrieving their order from the customer access portal. The dispensing system may be fully automated or may be partially operated by human associates, as desired at the particular store location. Thus, the dispensing system reduces wait times for customers, reduces human interaction, which may be beneficial for health purposes, and reduces labor force requirements for handling and dispensing customer e-commerce orders.

These and other objects, advantages, purposes and features of this invention will become apparent upon review of the following specification in conjunction with the drawings.

### BRIEF DESCRIPTION OF THE DRAWINGS

FIG. 1 is an exterior side perspective view of a set of contactless customer order pick-up portals of a contactless order dispensing system, in accordance with the present invention;

FIG. 2 is an interior side perspective view of the set of contactless customer order pick-up portals of FIG. 1 and a conveyer transportation system of the contact contactless order dispensing system;

FIG. 3 is another exterior side perspective view of the contactless order dispensing system of FIG. 1, depicted with an exterior wall omitted;

FIG. 4 is a plan view of an order fulfillment facility including the contactless order dispensing system of FIGS. 1; and

FIG. 5 is a diagram of a method for dispensing an order to a customer without human-to-human interaction, in accordance with the present invention.

### DESCRIPTION OF THE PREFERRED EMBODIMENTS

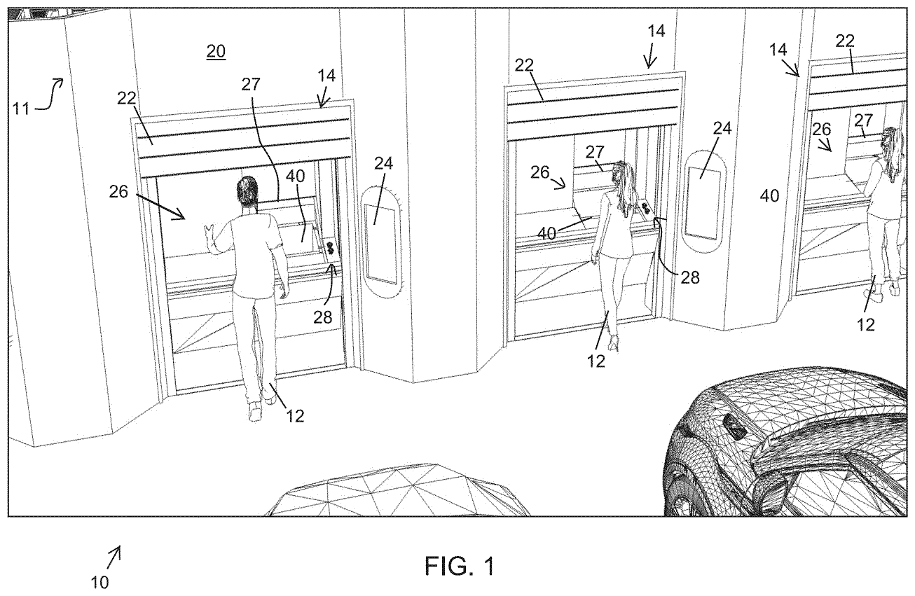

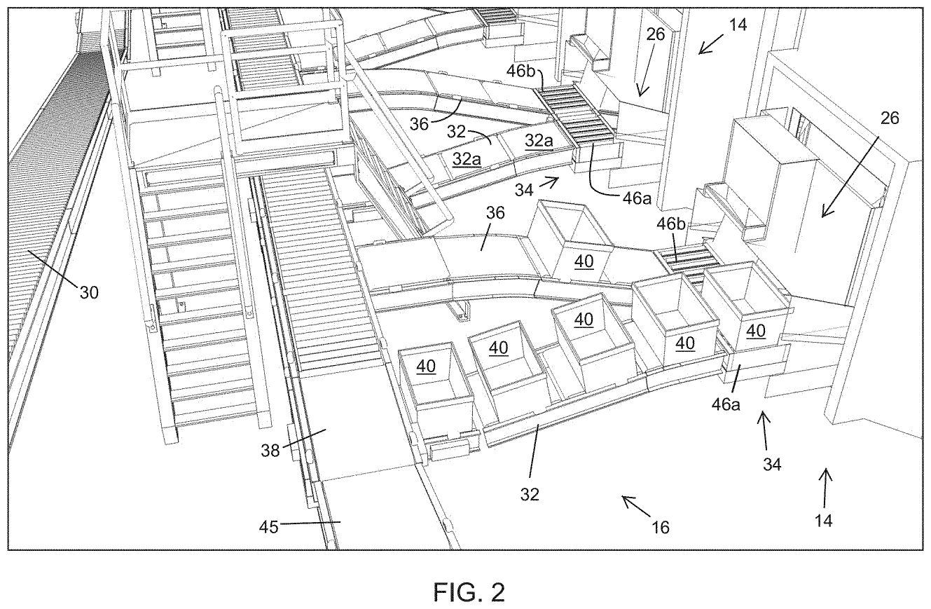

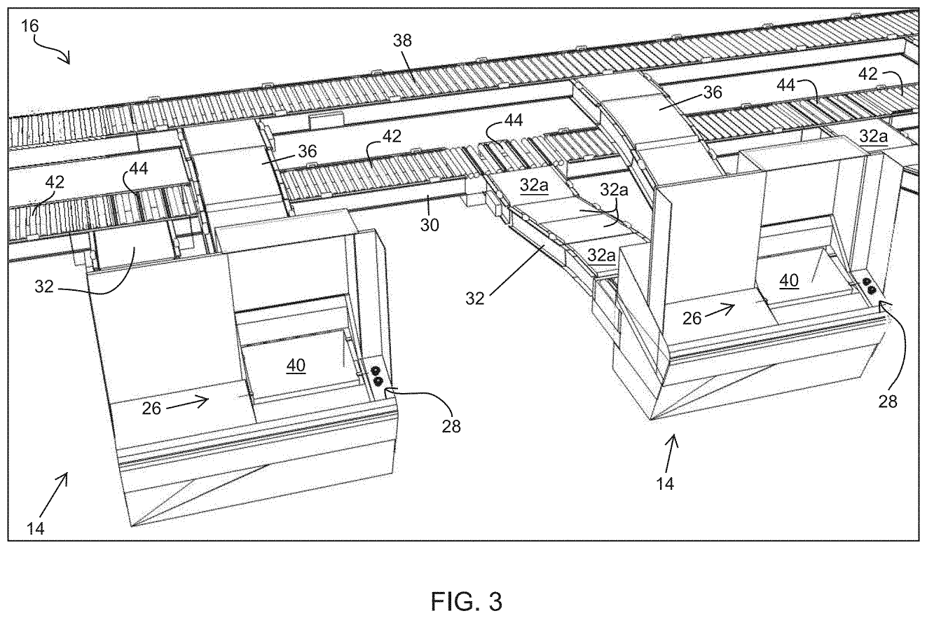

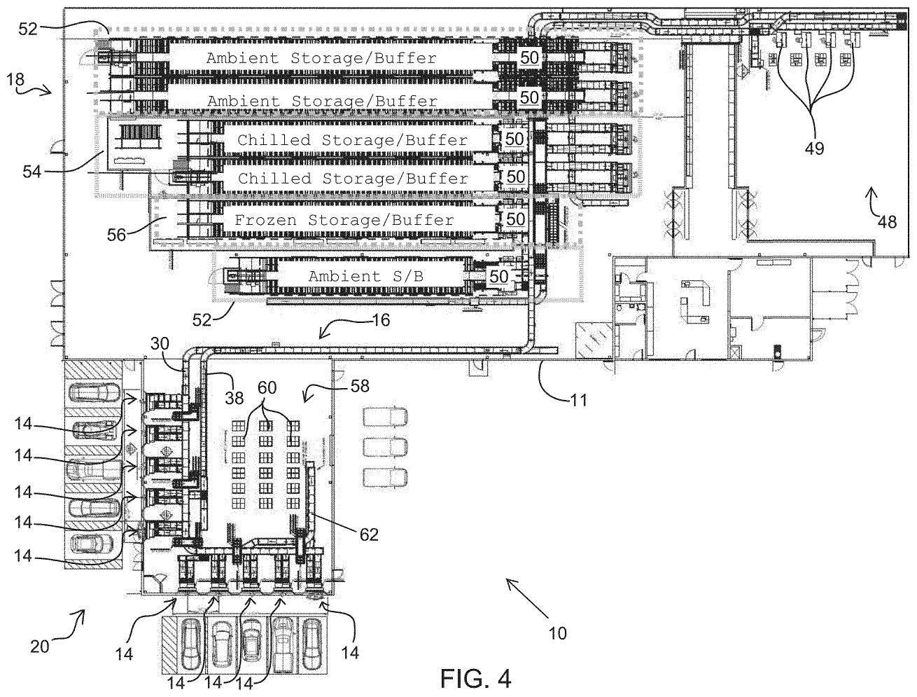

Referring now to the drawings and the illustrative embodiments depicted therein, a contactless order dispensing system 10 for dispensing e-commerce orders to customers 12 without the need for interaction between the customer and a human associate (FIG. 1). The dispensing system 10 includes a customer order pick-up or access portal 14 at which an order is presented to the customer 12 for retrieval. The dispensing system 10 is particularly beneficial for e-commerce micro-fulfillment operations (i.e. localized or small scale order fulfilment facilities), such as may be provided in a receiving portion or other non-customer accessible portion of a grocery store 11, department store, or retail store, to allow customers to retrieve their order from the exterior of the store without having a face-to-face or in-person interaction with another human (FIGS. 1 and 4). The dispensing system 10 allows the customer 12 to enter instructions to indicate that they are present and ready to retrieve their order. In addition to other benefits, this arrangement is particularly beneficial in limiting the spread of germs and disease, such as in times of public health emergencies, increased efficiency of space usage within order fulfillment facilities, and decreased customer wait times when retrieving their orders. The dispensing system 10 includes a transportation system, such as a conveyor system 16, in communication with the access portal 14 to transport the customer order to the access portal 14 (FIGS. 2-3) A storage buffer 18 is provided to store prepared customer orders until the customer 12 requests the order at the access portal 14 (FIG. 4). The dispensing system 10 is controlled by an order management system having a computer. The dispensing system 10 may include a confirmation system in communication with the order management system to verify that the customer 12 has retrieved all of the order contents from the access portal 14.

Referring to the illustrative embodiment of FIGS. 1-4, the contactless order dispensing system 10 includes multiple customer order pick-up/access portals 14 that are spaced apart from one another and accessible from an exterior 20 of the store 11. Each access portal 14 includes an exterior access door, shown in the form of an overhead roll-up type access door 22, and a customer/user interface or system 24 (FIG. 1). Upon arrival at the store and access portal 14, the customer 12 inputs unique customer information and/or order identifying information or credentials, such as an access code or pin number, into the user interface 24. For example, the user interface 24 may include a customer input device, such as an analog keypad or a touchscreen. Upon verification of the customer and order identifying information, the access door 22 opens to provide the customer access to an order dispenser 26. The order dispenser 26 may include a safety door that remains closed until the order contents have arrived at the access portal 14 such that the order contents are safely positioned, which may reduce or eliminate the possibility of injury to the customer 12 from interaction with the access portal components. A shroud 27 is provided around the order dispenser 26 to impede or prohibit the customer from accidently (or intentionally) inserting body parts into the order dispenser. Preferably, the opening in the shroud 27 is smaller in dimension than the dimensions of a transport receptacle in which the order is presented to the customer. As such, the customer is prohibited from removing the transport receptacle from the order dispenser 26. While it may be preferable that customer orders are transported and presented to the customer in a receptacle or tote 40, it is contemplated that some items and/or portions of a customer's order may be transported directly on the conveyor system 16 and presented to the customer 12 without a receptacle. Optionally, a proximity or motion sensor may be provided to open the access door 22 automatically when a customer arrives at the access portal 14. The access door 22 and/or order dispenser safety door may include an automatic reversal system, optical sensor, light-curtain, pressure sensor, or similar safety device, which, in the event that an object or customer is beneath the respective door, will automatically reverse the door if it has begun to close.

The access portal 14 includes a customer confirmation system, in the form of mechanical buttons 28, to allow the customer to confirm that they have completed retrieving their order or to indicate an issue with their order, such as indicating that an order item is damaged or is no longer wanted. While the confirmation system is illustrated as mechanical buttons 28 in FIGS. 1 and 3, it will be appreciated that a touchless sensor (e.g. an optical sensor) may be utilized to transmit image data to the order management system. The order management system utilizes the image data to confirm whether the customer has completed the retrieval of their entire order. In this manner, the touchless sensor and order management system cooperate to reduce contact points the customer must touch. The user interface 24 may include a scanner system to provide touchless input of the unique customer and order info, which may further reduce contact points that the customer must physically interact with or touch. The scanner system may be configured to scan and identification card or may be a biometric scanner. Further, an order dispenser monitoring system may be provided to confirm whether the order contents have arrived at or have been retrieved from the order dispenser 26. An exemplary order dispenser monitoring system is discussed in more detail below.

Referring to FIGS. 2 and 3, the transportation system of the dispensing system 10 is formed by a conveyor system 16 that includes a sortation system or sorter 30, an input conveyor 32, a transfer conveyor 34, a discharge conveyor 36, and a return conveyor 38. The conveyor system 16 typically transports receptacles, bins, or totes 40, which contain customer orders or portions of customer orders, to and from the access portal 14, however, it will be appreciated that orders and individual items may be transported along the conveyor system 16 without totes. The sorter 30 includes multiple roller conveyor segments 42 and right-angle-transfers (RATs) 44 adjacent to each of the input conveyors 32 for each access portal 14. The RAT 44 diverts order totes 40 from the sorter 30 to the adjacent input conveyor 32 of a particular access portal 14 that requires the order. The sorter 30 may include motor driven rollers and/or a motorized belt conveyor to move totes along the sorter 30 toward the various access portals 14. As best shown in FIG. 2, the input conveyor 32 is a segmented conveyor that functions as an accumulator to accumulate multiple order totes 40 along the input conveyor 32 in sequence until they are moved to the access portal 14. The segments of the input conveyor 32 may be independently controlled segmented belt-on-roller (SBOR) conveyors 32a, or any other suitable accumulator conveyor system.

The transfer conveyor 34 is positioned between the input conveyor 32, the access portal 14, and the discharge conveyor 36 (FIG. 2). The transfer conveyor 34 includes a pair of right-angle-transfers (RATs) 46a and 46b, with the first RAT 46a positioned at the downstream end of the input conveyor 32 and adjacent to the second RAT 46b which is positioned between the order dispenser 26 and the discharge conveyor 36. The first RAT 46a functions to receive totes 40 from the input conveyor 32 and buffer that tote while it waits to move onto the second RAT 46b. The second RAT 46b performs multiple functions including receiving the next order tote 40 from the first RAT 46a, transferring that tote 40 into the order dispenser 26 (which later returns the tote 40 to the second RAT 46b after the customer has completed order retrieval), and transferring the completed tote 40 from the order dispenser 26 to the discharge conveyor 36. The discharge conveyor 36 transfers completed order totes 40 to the return conveyor 38 (FIGS. 2 and 3). The return conveyor 38 may include motor driven rollers and/or a motorized belt conveyor 45 (FIG. 2) to move completed totes along the return conveyor 38 to return the completed totes to the order fulfilment pick system 48 or the storage buffer 18 as directed by the order management system. The order dispenser 26 includes a single motorized roller or belt conveyor section and an indexing system that receives the tote 40 from the second RAT 46b. The indexing system positions the tote 40 in an ergonomic pick-up position (e.g. angled at 15° down) to allow the customer to retrieve their order without removing or manipulating the tote 40. The order dispenser 26 also includes a locking device to retain the tote inside the order dispenser 26 so that the customer 12 cannot remove the tote 40.

A confirmation system may be provided to inspect the tote 40 to confirm that it is empty, or if the customer has indicated that they are rejecting an item (such as by entering an input at the user interface 24), that the tote contains something. The confirmation sensor may utilize various sensors or scanners, such as ultrasound, optical sensors, label scanners, etc. to inspect the tote that is present in the order dispenser 26. Optical sensors may create a two-dimensional or three-dimensional point map of the tote 40 and/or items present in the tote 40 to confirm whether the tote is empty or not. If the customer indicates that they are rejecting an item and if the confirmation system senses that an item is present in the tote, the order management system may assume that the present item is the item that the customer has indicated that they are rejecting. Optionally, the confirmation system may include a scanner, such as a barcode scanner or the like, to identify the particular item that is present in the tote. The order management system may confirm that the item, which the customer rejected, matches the item that is present in the tote. The order management system confirms that the tote status matches the expected status before proceeding. For example, the tote status and expected status match if the customer has indicated that they have completed picking up their order without indicating a rejected item and the confirmation sensor confirms that the tote is empty. For another example, the tote status and expected status match if the customer has indicated that they have completed retrieving their order and have rejected an item and the confirmation sensor confirms that something is present in the tote. If the tote and expected statuses match, a light curtain or similar sensor will activate above or otherwise proximate the order dispenser 26 to determine if the safety door is clear. If the safety door is clear, it will close automatically. Subsequent order totes for the customer's order index into the pickup position at the order dispenser 26 and the cycle repeats until the customer has picked up the entirety of their order. The dispensing system 10 may include a customer alert device to notify the customer if they have left an item in the access portal 14 by mistake.

For example, totes 40 index forward through the accumulation positions on the input conveyor 32 until they reach the first RAT 46a. The first tote to arrive at the first RAT 46a is immediately diverted sideways onto the second RAT 46b which immediately diverts the tote onto the single motorized roller or belt section. The indexing system indexes the tote in the pick-up position and the locking device retains the tote in the order dispenser. Once the tote 40 is in position in the order dispenser 26, the order dispenser safety door opens automatically to allow the customer to retrieve their order items from the tote 40. Once the customer indicates that they have completed retrieval of their order (by pressing one of the buttons 28, see FIGS. 1 and 3). At this point, the confirmation system inspects the tote 40 to confirm that it is empty or that an item is present if the customer has indicated that they are rejecting an item. Once the tote status matches the expected status, the light curtain activates above the tote opening, and if clear, the safety door will close automatically. Then the locking device releases the tote 40 and the single motorized roller or belt section transfers the completed tote 40 out of the order dispenser 26 onto the second RAT 46b. The second RAT 46b then transfers the completed tote 40 onto the discharge conveyor 36 and then immediately receives the next order tote 40 from the first RAT 46a. Subsequent order totes for the customer's order index into the pickup position and the cycle repeats until the customer has picked up the entirety of their order.

The input conveyors 32 and discharge conveyors 36 may be inclined, declined or level such that the conveyor system 16 can be positioned at various heights to meet the access portal 14. Likewise, the access portal 14 may be configured at different heights as necessary to meet customer requirements and preferences, such as at wheelchair accessible heights as determined by the American with Disabilities Act (ADA) requirements, standing height, or vehicle trunk height, etc. While the transportation system of the illustrated embodiment of FIGS. 2-4 is shown as a conveyor system 16, it is contemplated that an autonomous robotic vehicle or automated mobile robot (AMR) may transport the orders from the storage buffer 18 to the access portal 14. It is also contemplated that a conveyor system and one or more AMRs may be utilized to transport orders and totes between the storage buffer 18 and the access portal 14.

The sorter 30 and return conveyor 38 are connected with and in transport communication with an automated storage buffer 18, in the form of an automated storage and retrieval system (ASRS), that stores picked or completed customer orders until the customer arrives to retrieve their order. In order to provide fast service to customers 12 as they arrive at the store, the pick system 48 in the store begins picking the order, typically, as soon as the customer submits their order. The pick system 48 includes one or more order picking workstations 49, such as goods-to-person (GTP) workstations or goods-to-robot (GTR) workstations, at which operators pick order items into totes 40. Once the pick system 48 has picked the full order, the order tote 40 (or multiple totes for large orders or for orders containing different types of items, which will be discussed in further detail below) is transported to the storage buffer 18. The order management system controls the storage buffer 18 to position the filled order totes 40 inside the storage buffer 18 and to release order totes 40 to the access portal 14 once the customer 12 has arrived and instructed the dispensing system 10 that they are ready to retrieve their order.

Due to the nature of goods that a customer typically orders from a grocery store, it may be necessary to provide multiple temperature zones within the storage buffer 18 to maintain freshness and quality of the order items during the time between the customer placing the order and the customer retrieving the order. As illustrated in FIG. 4, the storage buffer 18 includes multiple temperature zones, with ASRS storage racks 50 located in each of the temperature zones. The exemplary temperature zones illustrated in FIG. 4 include an ambient temperature zone 52 for room temperature or similar items, a chilled temperature zone 54 for cooled or chilled items (i.e. at a lower temperature than the ambient zone 52), and a frozen temperature zone 56 for frozen items (i.e. at or below freezing temperature and at a lower temperature than the chilled zone 54). Fewer or additional temperature zones may be provided as desired to provide adequate temperature control for customer orders. If a customer order contains items that require different temperature zones, the order management system divides the order into multiple totes 40, which are each transported to and stored in the appropriate temperature zone. When the customer arrives and instructs the dispensing system 10 to retrieve their order, the order management system releases each of the totes for that order from the storage buffer 18, including from the different temperature zones. Preferably, all of the totes 40 for that order arrive at the access portal 14 in sequence so that the customer 12 receives all of their order in one consecutive stream of totes 40.

While the ASRS racks 50 of storage buffer 18 are described above and illustrated in FIG. 4 as being dedicated to a single temperature zone, it is contemplated that single storage rack 50 may be include two or more temperature zones within the rack which are maintained at two of more different temperatures. For example, the storage buffer may include an ASRS having a single storage rack that includes a group of levels maintained at a chilled temperature and another group of levels at a frozen storage temperature, such as described and illustrated in commonly owned and assigned U.S. Pat. No. 11,067,329, issued Jul. 20, 2021. Alternatively, instead of an ASRS storage buffer as illustrated in FIG. 4, it will be appreciated that the buffer may be a manual storage and retrieval system that is manually operated by human operators such that the human operator manually places orders into storage and retrieves the orders when the customer has arrived and is ready to pick-up their order. The human operator may transport the order, in a tote 40 for example, to the access portal 14 where it is presented to the customer at the order dispenser 26.

Preferably, the time required to release the customer order from the storage buffer 18, transport the order to the access portal 14, and ultimately present the order to the customer at the order dispenser 26 is less than ten (10) minutes, and more preferably less than five (5) minutes, and most preferably less than two (2) minutes.

As illustrated in FIG. 4, the dispensing system 10 may be adapted to dispense larger orders, such as for large volume orders for caterers, restaurants, or the like. The dispensing system may include a large order retrieval bay or space 58 that contains large order containers 60 (e.g. gaylords, pallets, etc.) and an operator or an automated mobile robot (AMR) transfers order items from a sorter extension 62 that is connected to the sorter 30 and places them into a large or container. When the customer arrives for their large volume order, the large order containers 60 can then be loaded onto a vehicle. AMRs may be used to load the large order containers 60 onto the vehicle to reduce or eliminate close contact between a store associate and the customer or vehicle driver.

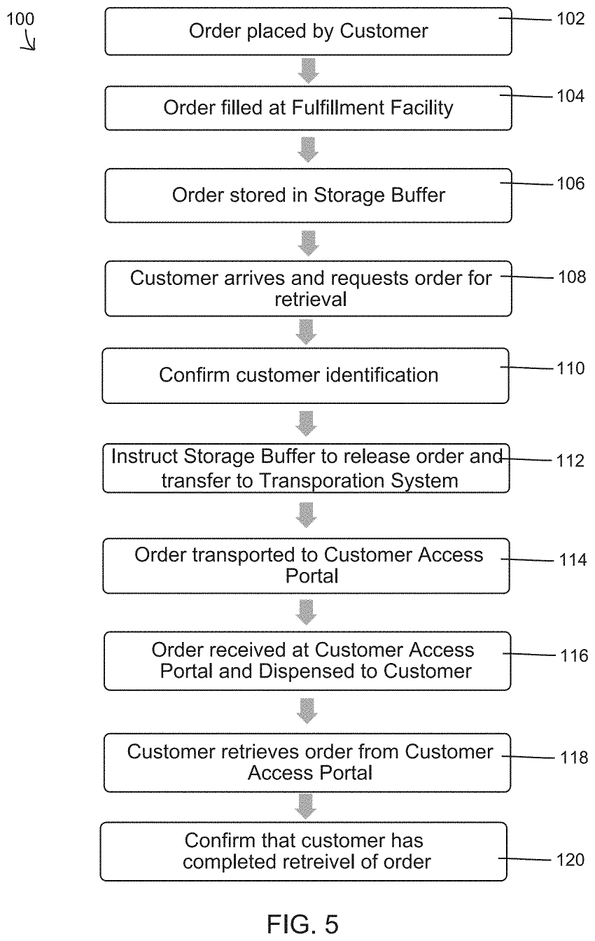

Referring to the illustrative embodiment of FIG. 5, a method 100 is provided for contactless dispensing of an order to a customer. Method 100 includes receiving 102 an order from a customer via the internet or other channel. The order data is stored in an order management system that includes a computer. The order 104 is prepared or filled in an order fulfilment pick system 48, which is onsite at a store location, such as a grocery store 11, department store, convenience store, or the like. After the order is filled, it is stored or buffered 106 in a storage buffer 18 until the customer 12 arrives to pick-up the order. When the customer arrives, the customer enters 108 identification information, such as an access code, into a user input device of a customer/user interface or system 24 to request their order. The order management system confirms 110 the customer identification info and instructs the storage buffer 18 to release 112 the customer's order. The method then includes transporting 114 the order from the storage buffer 18 with a transportation system, such as a conveyor system 16, to a customer order pick-up access portal 14. The access portal 14 receives and dispenses 116 the order to the customer in a manner such that the customer 12 does not have direct contact with a store associate or other human. The customer retrieves 118 the order and the order management system confirms 120, with a confirmation system including a confirmation sensor, that the customer has completed retrieval of their order.

Buffering 106 the order in a storage buffer 18 may include separating portions of the customer order and storing each portion in different temperature zones of the storage buffer as required for the different items in the order (e.g. ambient temperature zone 52, chilled temperature zone 54, and frozen temperature zone 56). The storage buffer 18 includes an automated storage and retrieval system store and buffer the order after it is filled in the pick system 48. Confirming 120 that the customer has retrieved their entire order is performed by an order management system that includes a computer and a confirmation system or sensor located proximate the access portal 14.

Dispensing 116 the order to the customer includes opening an order dispenser safety door between the customer 12 and the conveyor system 16 and presenting the order to the customer at the order dispenser 26 opening defined by the open safety door. The method 100 may notify the customer with an alert device, such as an audible signal or a light, that an order item is present at the access portal 14 and ready for retrieval. For example, the alert device may illuminate in the event that an item is left in a tote at the access portal 14 for an extended period of time without an indication from the customer that they are rejecting that item. The method 100 may also include receiving an instruction from the customer that they are rejecting at least one order item and the method 100 confirming that the rejected item is present at the access portal 14. The method 100 may utilize a scanner, camera, or ultrasound sensor to determine that the rejected item (or any item) is present at the access portal 14.

Preferably releasing 112 the order and transporting 114 the order from the storage buffer 18, receiving and dispensing 116 the order at the access portal 14 and dispensing the order to the customer are all performed in ten (10) minutes or less, and more preferably in five (5) minutes or less, and most preferably in two (2) minutes or less.

Thus, the present invention provides a contactless order dispensing system and method for dispensing an e-commerce order to a customer without the customer interacting with a human associate. The dispensing system includes a customer access portal, a storage buffer, and a transportation system to transport orders from the storage buffer to the access portal. The storage buffer receives filled orders from an order fulfillment facility that is on-site at the store location and releases the stored customer order when the customer has arrived at the store. The storage buffer includes multiple temperature zones to store portions of the customer order at different required temperatures. The customer access portal presents the order (or portions of the order) to the customer an exterior of the store location. The dispensing system includes a confirmation sensor system at the access portal to verify whether a customer has retrieved their entire order or whether the customer has rejected one or more of the order items and left the rejected item(s) in the tote. The dispensing system is capable of providing the order to the customer within about two minutes of the customer arriving at the access portal.

Changes and modifications in the specifically described embodiments can be carried out without departing from the principles of the present invention which is intended to be limited only by the scope of the appended claims, as interpreted according to the principles of patent law including the doctrine of equivalents.

1. A contactless order dispensing system comprising:
a customer access portal for presenting a customer order to a customer for retrieval by the customer;
a transportation system in communication with said customer access portal for transporting a customer order to said customer access portal;
a buffer in communication with said transportation system and configured to store a plurality of prepared customer orders until a particular one of the customer orders is requested by a corresponding customer at said customer access portal and to release that particular order when it is requested at said customer access portal;
an order management system comprising a computer and configured to control said dispensing system; and
a confirmation sensor in communication with said order management system and configured to verify that a customer has retrieved all contents of the particular order from said customer access portal.

2. The contactless order dispensing system of claim 1, wherein said transportation system comprises a conveyor system having at least one chosen from a roller conveyor system, a segmented belt on roller system, a belt conveyor system, and a right-angle transfer system.

3. The contactless order dispensing system of claim 2, wherein a majority of the plurality of customer orders are transported within a receptacle such that the receptacle is transported by said conveyor system and the customer order is presented to the customer at said customer access portal in the receptacle.

4. The contactless order dispensing system of claim 2, wherein said conveyor system is configured to accumulate and sequence multiple customer orders and portions of customer orders at said customer access portal.

5. The contactless order dispensing system of claim 1, wherein said buffer comprises a plurality of temperature zones for storing respective portions of a customer order at different required temperatures until the customer order is requested at said customer access portal, wherein each portion of the customer order is released from its respective temperature zone of said buffer such that all of the portions of the customer order arrive at said customer access portal simultaneously.

6. The contactless order dispensing system of claim 1, further comprising a customer user interface in communication with the order management system, said customer user interface comprising a customer input device for receiving a customer input indicating that the customer is ready to retrieve their order, wherein, upon receiving the customer input at said customer user interface, said order management system instructs said buffer to release that particular customer order and said transportation system to subsequently transport the customer order from said buffer to said customer access portal.

7. The contactless order dispensing system of claim 6, wherein said confirmation sensor is further configured to confirm if an item is present at said customer access portal after a customer has indicated at said customer user interface that they have intentionally left an item in said customer access portal.

8. The contactless order dispensing system of claim 1, further comprising a customer alert device to notify the customer if they have left an item in said customer access portal.

9. The contactless order dispensing system of claim 1, wherein said buffer comprises at least one chosen from an automated storage and retrieval system and a manual storage and retrieval system.

10. The contactless order dispensing system of claim 1, wherein said dispensing system, upon receiving instructions from the customer that they are ready to retrieve their order, is operable to retrieve the particular customer order from said buffer and present it to the customer at said customer access portal in about two minutes or less.

11. The contactless order dispensing system of claim 1, wherein said dispensing system comprises a plurality of said customer access portals in spaced arrangement and said transportation system comprises a sortation system to direct particular orders to corresponding customers at respective ones of said plurality of customer access portals.

12. The contactless order dispensing system of claim 1, wherein said transportation system comprises an automated mobile robot to transport an order from said buffer to said customer access portal.

13. A contactless order dispensing system for an order fulfilment facility that comprises an order management system having a computer, said dispensing system comprising:
a customer access portal for presenting a customer order to a customer in a contactless manner in which the customer is not required to interact directly with any human;
an automated buffer configured to store a plurality of prepared customer orders until a particular one of the customer orders is requested by a corresponding customer at said customer access portal and to release that particular order when it is requested at said customer access portal;
a transportation system operable to transport a customer order between said buffer and said customer access portal, said transportation system comprising at least one chosen from a conveyor system and an autonomous mobile robot; and
a customer user interface in communication with the computer of the order management system and comprising a customer input device for receiving a customer input indicating that a customer is ready to retrieve their corresponding customer order;
wherein, upon receiving the customer input at said customer user interface indicating that the customer is ready to retrieve their corresponding customer order, the order management system controls said buffer to release the corresponding customer order and controls said transportation system to subsequently transport the corresponding customer order from said buffer to said customer access portal.

14. A method for contactless dispensing of an order to a corresponding customer, said method comprising:
preparing a customer order within an order fulfilment facility;
buffering the customer order in a storage buffer of an order dispensing system until the corresponding customer arrives to pick-up the order, the storage buffer configured to store and buffer a plurality of prepared customer orders;
receiving an instruction that the corresponding customer has arrived to retrieve the customer order;
transporting the customer order from the storage buffer with a transportation system;
receiving the customer order from the transportation system at a customer access portal;
dispensing the customer order to the customer with the customer access portal in a manner such that the customer is not required to have direct contact with another human; and
confirming that the customer has retrieved the entire order from the customer access portal with a confirmation sensor proximate the customer access portal.

15. The method for contactless dispensing of claim 14, wherein said buffering the order in a storage buffer comprises storing portions of items of the customer order in different temperature zones of the storage buffer based on respective temperature storage requirements of different types of items present in the customer order.

16. The method for contactless dispensing of claim 14, wherein the order dispensing comprises an order management system having a computer in communication with the confirmation sensor, wherein said confirming that the customer has retrieved the entire order comprises the computer receiving data from the confirmation sensor and determining, based on the data received from the confirmation sensor, whether the customer has retrieved the entire order from the customer access portal.

17. The method for contactless dispensing of claim 14, wherein said dispensing the customer order to the customer comprises opening an access door of the customer access portal that is positioned between the customer and the transportation system, and presenting the customer order to the customer at an opening defined by the open access door.

18. The method for contactless dispensing of claim 14, further comprising notifying a customer that an order item is present at the customer access portal and ready for retrieval.

19. The method for contactless dispensing of claim 14, further comprising receiving an instruction from the customer that they are rejecting at least one order item and confirming with the confirmation sensor that the rejected item is present at the customer access portal.

20. The method for contactless dispensing of claim 14, wherein said transporting the order from the storage buffer, said receiving the order at the customer access portal, and said dispensing the order to the customer are all performed in about two minutes or less.
